(19) United States
(12) Patent Application Publication
(10) Pub. No.: US 2011/0000399 A1
(43) Pub. Date: Jan. 6, 2011

(54) FATTY ACID SALT MIXTURE AS A HYDROPHOBING AGENT FOR CONSTRUCTION MATERIALS

(75) Inventor: Juergen Hauk, Freising (DE)

Correspondence Address: McKeon Meunier Carlin & Curfman LLC, 817 W. Peachtree Street, Suite 900, Atlanta, GA, 30308, US

(73) Assignee: BAERLOCHER GMBH, Unterschleissheim (DE)

(21) Appl. No.: 12/810,590

(22) PCT Filed: Dec. 15, 2008
(86) PCT No.: PCT/EP08/10656

§ 371 Date: Sep. 14, 2010

(30) Foreign Application Priority Data
Dec. 27, 2007 (DE) 102007062772.8-43

(51) Int. Cl. C04B 16/00; C09K 3/18

(52) U.S. Cl. 106/661; 106/419; 106/471; 106/504

(57) ABSTRACT

The invention relates to hydrophobing agents for mineral construction materials, the use thereof, methods for the production thereof, mineral construction materials, and constructional parts. The hydrophobing agents according to the invention contain fatty acid salts that comprise a mixture of fatty acid salts of at least two different metal cations or two different ammonium cations or a mixture of at least one metal cation and at least one ammonium cation. The metal cations are selected from the group comprising alkali metals, alkaline earth metals, zinc, aluminum, and rare earths. The content of fatty acid salts of fatty acids that have 8 to 17 C atoms amounts to at least 20 percent by weight relative to the total amount of fatty acid salts in the fatty acid salt mixture.

The invention provides fatty acid salt mixtures which are especially suitable as hydrophobing agents for construction materials, processes for preparation thereof, and mineral construction materials and components. The inventive fatty acid salt mixtures comprise fatty acid salts among which the proportion of the fatty acid salts of fatty acids having 8 to 17 carbon atoms, based on the total amount of the fatty acid salts in the fatty acid salt mixture, amounts to 20% by weight or more than 20% by weight, or the proportion of fatty acids having 8 to 14 carbon atoms amounts to 10% by weight or more than 10% by weight, based on the total amount of the fatty acid salts in the fatty acid salt mixture, or both.

The fatty acid salts preferably comprise a mixture of salts which contains at least two different cations, for example metal cations or ammonium cations or both, the metal cations being selected especially from the group consisting of alkali metal, alkaline earth metal, zinc, aluminum and rare earth cations. The fatty acid salt mixtures are especially suitable for waterproofing mineral construction materials.

Mineral construction materials, for example render for exterior walls, are often hydrophobized in order to very substantially prevent the set materials from absorbing moisture from the environment. “Hydrophobing” is understood to mean the waterproofing of a construction material. This utilizes a physicochemical effect which can be derived from the capillary laws. Hydrophobing is typically an impregnation process, with the aid of which the wetting angle of water with respect to the construction material is often raised. The capillary adsorbtivity can be reduced or raised as a result, and the water absorption capacity of the construction materials is frequently reduced (the construction materials are hydrophobized), without the water vapor permeability, which is important for the breathing activity of the construction material, being altered significantly. This is because there is generally no sealing of the capillaries, but instead, at least predominantly, merely coating of the capillary walls with substantial retention of the open-pore structure necessary for the diffusion processes. Hydrophobizations are accordingly generally not sealing measures.

According to the prior art, the hydrophobing agents used may be metal soaps or silicone compounds. The metal soaps are often salts of fatty acids having 18 carbon atoms, especially stearates and oleates. In addition, derivatives of fatty acids, such as esters, and fats and oils are used as hydrophobing agents.

EP 1 328 486 B1 relates to granulated hydrophobing additives for cement compositions. These contain salts of palmitic acid, stearic acid or oleic acid, an organopolysiloxane, and optionally paraffin and a binder.

DE 103 23 205 A1 discloses hydrophobing additives based on fatty acids and derivatives thereof. The fatty acids are used in conjunction with water-soluble protective colloids and optionally in combination with antiblocking agents and organosilicon compounds.

DE 10101190 A1 provides powder compositions for hydrophobing construction materials, which comprise at least one carboxylic ester.

German published specification 2341085 discloses construction coating materials consisting of cement or lime, fillers and water, which additionally comprise sucrose esters of fatty acids.

German published specification DE 10 2004 059 377 A1 discloses a hydrophobing, water-redispersible polymer powder based on a polymer, a protective colloid and optionally further additives, such as fatty acids, fatty acid derivatives and antiblocking agents. Similar compositions are described in DE 10 2004 026 610 A1.

EP 0 351 521 B1 describes primer compositions for a waterproofing agent, which comprises fatty acids, binders and organic solvents.

EP 1 328 486 B1 describes a granulated hydrophobing agent for cement compositions, which comprises fatty acid salts of palmitic acid, stearic acid or oleic acid in conjunction with a water-soluble or water-dispersible binder and optionally an organopolysiloxane.

DE 3238390 A1 relates to dry mortars with binders based on cement or gypsum, which may comprise glyceryl esters of higher fatty acids.

DE 196 33 131 A1 provides gypsum-containing compositions which may contain a multitude of fatty acid derivatives, such as epoxidized oils, polymerized fatty acids and modified fatty acids.

Japanese published specification JP 02142880 A discloses the improvement of the water-repellent properties of gypsum by adding natural oils, such as linseed oils or coconut oil.

DE 103 51 259 A1 relates to hydrophobing agents for drying mortars, which comprise fatty acids. Preference is given to stearates and oleates.

U.S. Pat. No. 3,009,820 discloses compositions in which oils from wood processing are treated with calcium hydroxide. Such oils contain a high proportion of long-chain fatty acids.

In the case of the known hydrophobing agents, the problem occurs that the hydrophobing action after setting frequently decreases within a few days or weeks. For instance, in the case of use of metal soaps, especially in the case of use of the stearates and oleates customary according to the prior art, a significant decrease in the water-repellent properties is found as early as after about 4 weeks. This problem occurs particularly in the case of use of renders based on cement or mortar.

A further problem is that the ease of handling of the known hydrophobing agents is not always satisfactory. For instance, especially the known agents such as zinc stearate are wettable only with difficulty, which complicates homogeneous incorporation into a construction material. Such hydrophobing agents tend to form lumps, which impairs the water-repellent properties of the set component overall.

It is therefore an object of the present invention to provide a fatty acid salt mixture which overcomes the problems mentioned in the case of use as a hydrophobing agent. The inventive fatty acid salt mixture should ensure a marked hydrophobing effect even over prolonged periods. In addition, good ease of handling and homogeneous distribution into a construction material should be ensured. This should prevent or at least significantly attenuate any attenuations in the water-repellent action and the prevention of efflorescence in the product as a result of irregular distribution.

The fatty acid salt mixture should also be preparable in a simple manner and very inexpensively. It should have a high storage stability and be suitable for a broad spectrum of applications.

Unless stated otherwise, figures in % hereinafter relate to % by weight.

The problem underlying the invention is surprisingly solved by fatty acid salt mixtures, the use thereof, processes for preparation thereof, mineral construction materials and components as described within the present text.

The invention provides a fatty acid salt mixture comprising a mixture of fatty acid salts of at least two different metal cations or two different ammonium cations or a mixture of at least one metal cation and at least one ammonium cation, the metal cations being selected from the group consisting of alkali metals, alkaline earth metals, zinc, aluminum and rare earths, and the proportion of the fatty acid salts of fatty acids having 8 to 17 carbon atoms, based on the total amount of the fatty acid salts in the fatty acid salt mixture, amounting to 20% by weight or more than 20% by weight, or the proportion of fatty acids having 8 to 14 carbon atoms amounting to more than 10% by weight, based on the total amount of the fatty acid salts in the fatty acid salt mixture, or both.

“Fatty acids” in the context of the invention refer to mono- or polycarboxylic acids having at least 6 carbon atoms, i.e. compounds which have at least one carboxyl group and branched or unbranched carbon chains. “Fatty acid salts” are understood in the context of the present text to mean salts, especially the metal salts, of the abovementioned fatty acids. The fatty acid salts are also referred to as soaps. A “fatty acid” in the inventive sense may additionally bear double bonds, hydroxyl groups or epoxy groups.

Suitable constituents of the inventive fatty acid salt mixtures are the salts of the saturated fatty acids and the salts of the unsaturated fatty acids. It may be preferable to use the salts of the saturated fatty acids, but it has also been found to be advantageous in some cases to use the salts of the unsaturated fatty acids.

Suitable metal cations for formation of the fatty acid salt mixtures are especially metal cations selected from the group of the cations of alkali metals, alkaline earth metals, zinc, aluminum and rare earths.

Preferred alkali metal salts are the salts of lithium, sodium and potassium. Preferred alkaline earth metal salts are the salts of magnesium, calcium, strontium and barium. Among the salts of the rare earths, especially cerium and lanthanum are suitable.

In a preferred embodiment of the invention, the fatty acid salts are a mixture which comprises at least one fatty acid salt from the group of the alkali metal salts and at least one fatty acid salt from the group of the alkaline earth metal salts or of the salts of at least one metal from the group of the rare earths. It may be preferable when an inventive fatty acid salt mixture comprises a mixture of at least one alkali metal salt and at least one alkaline earth metal salt. For example, suitable fatty acid salt mixtures are those which comprise the sodium or potassium salts and calcium or magnesium salts of correspondingly suitable fatty acids.

In a further preferred embodiment, for example, a mixture of sodium salts and calcium salts is used. In a further preferred embodiment of the invention, the inventive fatty acid salt mixtures comprise a mixture of about 10 to about 50% by weight of sodium salts and about 90 to about 50% by weight of calcium salts, based on the total weight of the fatty acid salts in the fatty acid salt mixture. It is particularly preferable to use sodium salts and calcium salts in a weight ratio of about 1:2.

When an inventive fatty acid mixture comprises fatty acids of different chain length, it may be possible in principle that the metal cations are present in essentially random distribution over the fatty acids with different chain lengths. When an inventive fatty acid mixture comprises saturated and unsaturated fatty acids, it may be possible in principle that the metal cations are present in essentially random distribution over the saturated and unsaturated fatty acids. However, it is likewise envisaged in the context of the present invention that different fatty acids, which differ, for example, in the chain length or in the saturation, have different metal cations in a statistically significant manner.

For example, it is possible in accordance with the invention that a fatty acid salt mixture comprises two or more salts of fatty acids, in which case, for example, one particular fatty acid radical in each case bears a particular metal cation, while another fatty acid radical bears another metal cation. In this case, for example, mixtures of fatty acid salts which contain a mixture of sodium cations and calcium cations may be preferable.

Suitable fatty acid salt mixtures are obtained, for example, in a particular embodiment, when a fat or oil is reacted with suitable metal compounds, for example metal oxides, metal hydroxides, metal carbonates or metal salts of mineral acids, for example sodium hydroxide and calcium hydroxide.

For example, it is possible first to add a particular metal salt and then a further metal salt to the reaction mixture. The amounts of the metal salt are selected, for example, stoichiometrically with respect to the amounts of the desired salts. In a particular embodiment of the invention, the direct process product of such a reaction can be used as the fatty acid salt mixture. In this case, no further purification steps are required after the hydrolysis step.

In the context of the present invention, suitable cations in fatty acid ammonium salts suitable in accordance with the invention are in principle all compounds which lead, through appropriate conversion, to an ammonium salt of the corresponding fatty acid. Within the present text, ammonia is also referred to as “amine”. In this case, inventive ammonium salts can be obtained, for example, by appropriate conversion of amines or amides, such as alkylmonoamines, alkyldiamines, alkylpolyamines, dialkylamines or polyalkylamines. Suitable ammonium salts therefore derive, for example, from primary mono- or polyamino compounds having 2 to about 40, for example 6 to about 20, carbon atoms. Examples are ammonia, methylamine, ethylamine, n-propylamine, i-propylamine, n-propylamine, sec-propylamine, tert-butylamine, the isomeric pentylamines, hexylamines, heptylamines and the higher homologs thereof having 8, 9, 10, 11, 12, 13, 14, 15, 16, 17, 18, 19, 20, 21 or 22 carbon atoms, for example stearylamine, 1-aminoisobutane, substituted amines having 2 to about 20 carbon atoms, such as 2-(N,N-dimethylamino)-1-aminoethane. Suitable diamines have, for example, a molecular weight of about 32 to about 200 g/mol, where the corresponding diamines have, for example, two primary, two secondary or one primary and one secondary amino group. Examples thereof are diaminoethane, the isomeric diaminopropanes, the isomeric diaminobutanes, the isomeric diaminohexanes, piperazine, 2,5-dimethylpiperazine, amino-3-aminomethyl-3,5,5-trimethylcyclohexane (isophorone-diamine, IPDA), 4,4′-diaminodicyclohexylmethane, 1,4-diaminocyclohexane, aminoethylethanolamine, hydrazine, hydrazine hydrate or triamines such as diethylenetriamine or 1,8-diamino-4-aminomethyloctane. Triethylamine, tributylamine, dimethylbenzylamine, N-ethyl-, N-methyl-, N-cyclohexylmorpholine, dimethylcyclohexylamine, dimorpholinodiethyl ether, 1,4-diazabicyclo[2.2.2]octane, 1-azabicyclo[3.3.0]-octane, N,N,N′,N′-tetramethylethylenediamine, N,N,N′,N′-tetramethylbutanediamine, N,N,N′,N′-tetramethylhexanediamine-1,6, pentamethyldiethylenetriamine, tetramethyldiaminoethyl ether, bis(dimethylamino-propyl)urea, N,N′-dimethylpiperazine, 1,2-dimethyl-imidazole or di(4-N,N-dimethylaminocyclohexyl)methane.

Likewise suitable are aliphatic amino alcohols having 2 to about 40, preferably 6 to about 20, carbon atoms, for example triethanolamine, tripropanolamine, tributanolamine, tripentanolamine, 1-amino-3,3-dimethylpentan-5-ol, 2-aminohexane-2′,2″-diethanolamine, 1-amino-2,5-dimethylcyclohexan-4-ol, 2-aminopropanol, 2-aminobutanol, 3-aminopropanol, 1-amino-2-propanol, 2-amino-2-methyl-1-propanol, 5-aminopentanol, 3-aminomethyl-3,5,5-trimethylcyclohexanol, 1-amino-1-cyclopentanemethanol, 2-amino-2-ethyl-1,3-propanediol, 2-(dimethylaminoethoxy)ethanol, aromatic-aliphatic or aromatic-cycloaliphatic amino alcohols having 6 to about 20 carbon atoms, where, as aromatic structures, heterocyclic or isocyclic ring systems such as naphthalene or especially benzene derivatives, such as 2-aminobenzyl alcohol, 3-(hydroxymethyl)aniline, 2-amino-3-phenyl-1-propanol, 2-amino-1-phenylethanol, 2-phenylglycinol or 2-amino-1-phenyl-1,3-propanediol, and mixtures of two or more such compounds.

Likewise suitable as ammonium salts are, for example, compounds in which the amino group is present bonded to a substituted aromatic or heteroaromatic system, for example aminobenzoic acid, aminosalicylic acid or aminopyridinecarboxylic acid, and suitable derivatives thereof.

In a further embodiment of the invention, the proportion of the fatty acid salts having 8 to 17 carbon atoms in all of the fatty acid salts is more than 30, 50, 60, 70 or 80% by weight.

In a further embodiment of the invention, the proportion of fatty acids having 8 to 14 carbon atoms is 10% by weight or more than 10% by weight, for example more than, based on the total amount of fatty acid salts in the fatty acid mixture, for example, 20% by weight or more than 20% by weight or 30% by weight or more than 30% by weight or 40% by weight or more than 40% by weight or 50% by weight or more than 50% by weight or 60% by weight or more than 60% by weight or 70% by weight or more than 70% by weight or 80% by weight or more than 80% by weight or 90% by weight or more than 90% by weight.

In a further embodiment of the invention, the fatty acid salt which amounts to the greatest proportion in percent by weight of all of the fatty acid salts is a salt of a fatty acid having 8 to 17 carbon atoms. It is more preferably a laurate or a myristate.

In a preferred embodiment of the invention, the mean chain length of all of the fatty acid salts present in the fatty acid salt mixture is 9 to 16 carbon atoms, especially 10 to 14 carbon atoms.

In a preferred embodiment of the invention, an inventive fatty acid salt mixture comprises fatty acid salts selected from the group consisting of fatty acid salts of caprylic acid, pelargonic acid, capric acid, lauric acid, lauroleic acid, myristic acid, myristoleic acid, palmitic acid, palmitoleic acid, margaric acid, undecylenic acid and palmitoleic acid. Further preferred fatty acids are linoleic acid and linolenic acid. Further examples of suitable fatty acids are those which have one or more OH groups or one or more epoxy groups.

In a further embodiment of the invention, the sum of the proportions of the fatty acid salts of the caprylates, laurates and myristates in all of the fatty acid salts present in the inventive fatty acid salt mixture amounts to more than 50% by weight. In a further embodiment, the proportion of the laurates is greater than 30% and especially greater than 40% by weight. In a preferred embodiment of the invention, the proportion of the stearates is less than 10% and especially less than 5%. In a further preferred embodiment, the proportion of the oleates is less than 15% and especially less than 10%. It is particularly preferred when the proportion of salts of fatty acids having 18 carbon atoms, especially of stearates and/or oleates, in the inventive hydrophobing agent is less than 25%, especially less than 15% or 10%.

In a further embodiment of the invention, the total proportion of the fatty acid salts in the inventive fatty acid salt mixture is between 5 and 95% by weight, more preferably between 10 and 90% or between 20 and 85%. In preferred embodiments, the proportion of the fatty acid salts is higher than 10%, 20% or 50%.

In a further embodiment of the invention, the fatty acid salts are hydrolysis products of a natural fat or oil. “Natural” in the context of the invention means that the fat or oil originates from a natural source. The fat or oil may, however, also be aftertreated in accordance with the invention, for example by partial or full hydrogenation or by epoxidation of double bonds. Additives may also be added to the fat or oil. Particularly suitable in accordance with the invention are natural fats or oils which contain a comparatively high proportion of fatty acids with short chain lengths. Particular preference is given in accordance with the invention to the use of coconut oil, especially of coconut oil with a high proportion of lauric acid (from 45 to 51% by weight) and myristic acid (16.5 to 18.5% by weight), which is also referred to as coconut fat or coconut butter. Likewise suitable is palm kernel fat.

The natural fats are hydrolyzed, for example, by addition of metal hydroxides.

An inventive fatty acid salt mixture may, in addition to the above-described fatty acid salts, also contain further ingredients. Examples are polyhydric alcohols. Polyhydric alcohols refer to compounds which have at least 2 OH groups. In principle, linear, branched, saturated or unsaturated and homocyclic or heterocyclic unsaturated alcohols are suitable as a constituent of the inventive fatty acid salt mixtures. However, it has been found to be advantageous in some cases when the polyhydric alcohols used are compounds which have only carbon, hydrogen and oxygen as atomic constituents. The molar mass of corresponding polyhydric alcohols may be between about 62 (ethylene glycol) and several thousand, for example about 10. An inventive fatty acid salt mixture may contain, for example, only one polyhydric alcohol or two or more polyhydric alcohols. The alcohols may differ, for example, in their molar masses or in the number of the OH groups or in several different features.

Suitable examples are polyhydric alcohols such as ethylene glycol, propylene glycol, butylene glycol, pentylene glycol, hexylene glycol, propanetriol, trimethylolpropane, pentaerythritol, dihydroxycyclo-hexane, diethylene glycol, triethylene glycol and the dimeric, trimeric or oligomeric derivatives of the abovementioned dialcohols, oligoglycerol, polyglycerol, polyvinyl alcohol and the like.

It may be preferred in accordance with the invention when a fatty acid salt mixture contains a low molecular weight polyhydric alcohol having 2, 3 or 4 OH groups, especially propanetriol.

The proportion of polyhydric alcohol or polyhydric alcohols is, when these compounds are present in the inventive fatty acid salt mixture, up to about 40% by weight, especially about 1 to about 30 or about 5 to about 20 or about 8 to about 13% by weight.

An inventive fatty acid salt mixture may further comprise one or more monoalcohols, for example fatty alcohols. Suitable alcohols here are linear or branched, saturated or unsaturated aliphatic, monofunctional alcohols, especially methanol, ethanol, the isomers of propanol, of butanol or of hexanol, and fatty alcohols having about 8 to about 22 carbon atoms, for example octanol, decanol, dodecanol, tetradecanol, hexadecanol or octadecanol be used. The fatty alcohols mentioned are obtainable, for example, by reduction of natural fatty acids and can be used either as pure substances or in the form of the technical-grade mixtures thereof. Very suitable examples are linear monoalcohols and especially those having about 4 to about 18 carbon atoms. Instead of the linear or branched aliphatic alcohols or in a blend therewith, monoalkyl polyether alcohols of different molecular weight are also useable, preferably in the molecular weight ranges of about 1000 to about 2000.

The inventive fatty acid salt mixture can in principle be used for any purposes. However, it has been found in the context of the present invention that the fatty acid salt mixture has excellent suitability for imparting particular properties to construction materials with regard to the interaction thereof with water, more particularly for hydrophobizing these construction materials. An inventive fatty acid salt mixture is thus suitable as a hydrophobing agent. When reference is made to hydrophobing agents in the context of the present text, this should also be understood as a reference to the inventive fatty acid salt mixtures.

In a further embodiment of the invention, the fatty acid salt mixture comprises additives. Suitable additives are, for example, solvents, binders, solubilizers, fillers, further hydrophobing agents, surfactants, emulsifiers, viscosity improvers, pigments, dyes, preservatives, gelating agents, anticaking agents, pH modifiers, buffers, reaction accelerants, reaction retardants, colloids, polymers or air entrainers, or mixtures of two or more thereof.

An inventive fatty acid salt mixture may additionally comprise, for example, binders, surfactants, emulsifiers, colloids or polymers. These additives are present, for example, in order to improve the dispersibility and miscibility of the fatty acid salt mixture with a further material, especially a construction material. Appropriate additives useable in accordance with the invention are fatty acid derivatives, such as esters, waxes, polymers, especially ionic polymers and surfactants, or emulsifiers.

Solvents are present in the fatty acid salt mixture, for example, when it is to be used as a liquid composition. Suitable solvents are, for example, water or organic solvents such as alcohols, for example ethanol.

The binders used are, for example, water-soluble or water-dispersible binders. Such substances are known in the literature. Preference is given to using substances which have a waxy, highly viscous or solid consistency at room temperature, i.e. between 20 and 25° C., and which have a melting point of 25° C. to 150° C. Examples of customary corresponding binding materials are polyvinyl alcohol, methylcellulose, carboxymethyl-cellulose, ethoxylated fatty alcohols or mixtures thereof. In addition, it is possible to use fatty acid esters or film-forming polymers. The binding materials should disrupt the hydration process of the construction material to a minimum degree, if at all, when water is introduced.

In a further embodiment of the invention, an inventive composition comprises one or more surfactants or emulsifiers. Examples of suitable surfactants or emulsifiers include anionic surfactants, nonionic surfactants or cationic surfactants. It has been found in some cases that the presence of surfactants lowers the amount of hydrophobing agent required to achieve a desired hydrophobing effect. This does not correspond to expectation on addition of a hydrophilic substance and is, without wishing to be bound to a particular theory, possibly attributable to improved distribution of the hydrophobing agent in the composition.

Typical examples of anionic surfactants suitable in the context of the inventive fatty acid salt mixtures (also referred to hereinafter as “compositions”) are soaps, alkylbenzenesulfonates, secondary alkanesulfonates, olefinsulfonates, alkyl ether sulfonates, glyceryl ether sulfonates, α-methyl ester sulfonates, sulfo fatty acids, alkyl and/or alkenyl sulfates, alkyl ether sulfates, glyceryl ether sulfates, hydroxy mixed ether sulfates, fatty alcohol (ether) phosphates, monoglyceride (ether) sulfates, fatty acid amide (ether) sulfates, mono- and dialkyl sulfosuccinates, mono- and dialkyl sulfosuccinamates, sulfotriglycerides, amide soaps, ether carboxylic acids and salts thereof, fatty acid isethionates, fatty acid sarcosinates, fatty acid taurides, N-acylamino acids, for example acyl lactylates, acyl tartrates, acyl glutamates and acyl aspartates, alkyloligoglucoside sulfates, protein fatty acid condensates (especially wheat-based vegetable products) and alkyl (ether) phosphates. When the anionic surfactants contain polyglycol ether chains, they may have a conventional, but preferably a narrowed, homolog distribution.

Preference is given to anionic surfactants selected from the group formed by alkyl and/or alkenyl sulfates, alkyl ether sulfates, alkylbenzenesulfonates, soaps, monoglyceride (ether) sulfates and alkanesulfonates, especially fatty alcohol sulfates, fatty alcohol ether sulfates, secondary alkanesulfonates and linear alkylbenzenesulfonates.

Alkyl and/or alkenyl sulfates, which are also frequently referred to as fatty alcohol sulfates, are understood to mean the sulfation products of primary alcohols. Typical examples of alkyl sulfates which may find use in the context of the invention are the sulfation products of caproyl alcohol, caprylyl alcohol, capryl alcohol, 2-ethylhexyl alcohol, lauryl alcohol, myristyl alcohol, cetyl alcohol, palmoleyl alcohol, stearyl alcohol, isostearyl alcohol, oleyl alcohol, elaidyl alcohol petroselinyl alcohol, arachyl alcohol, gadoleyl alcohol, behenyl alcohol and erucyl alcohol, and the technical-grade mixtures thereof, which are obtained by high-pressure hydrogenation of technical-grade methyl ester fractions or aldehydes from the Roelen oxo process. The sulfation products can preferably be used in the form of the alkali metal salts and more particularly the sodium salts thereof. Particular preference is given to alkyl sulfates based on C_{16/18} tallow fatty alcohols or vegetable fatty alcohols of comparable carbon chain distribution, in the form of the sodium salts thereof.

Alkyl ether sulfates (“ether sulfates”) are known anionic surfactants which are prepared on the industrial scale by SO₃ sulfation or chlorosulfonic acid (CSA) sulfation of fatty alcohol polyglycol ethers or oxo alcohol polyglycol ethers, and subsequent neutralization. Typical examples are the sulfates of addition products of an average of 1 to 10 mol and especially 2 to 5 mol of ethylene oxide onto caproyl alcohol, caprylyl alcohol, 2-ethylhexyl alcohol, capryl alcohol, lauryl alcohol, isotridecyl alcohol, myristyl alcohol, cetyl alcohol, palmoleyl alcohol, stearyl alcohol, isostearyl alcohol, oleyl alcohol, elaidyl alcohol, petroselinyl alcohol, arachyl alcohol, gadoleyl alcohol, behenyl alcohol, erucyl alcohol and brassidyl alcohol, and the technical-grade mixtures thereof in the form of the sodium and/or magnesium salts thereof. The ether sulfates may have either a conventional or a narrowed homolog distribution. Particular preference is given to the use of ether sulfates based on adducts of an average of 2 to 3 mol of ethylene oxide on technical-grade C_{12/14} or C_{12/18} coconut fatty alcohol fractions in the form of the sodium and/or magnesium salts thereof.

The alkylbenzenesulfonates used may, for example, be dodecylbenzenesulfonates, tetradecylbenzenesulfonates, hexadecylbenzenesulfonates, and the technical-grade mixtures thereof in the form of the sodium salts.

Soaps are finally understood to mean fatty acid salts of the linear or branched, saturated or unsaturated carboxylic acids having 6 to 22 and preferably 12 to 18 carbon atoms, where the cation present may, for example, be an alkali metal and/or alkaline earth metal, ammonium, alkylammonium or alkanolammonium ion. The soaps mentioned here should be understood as an addition to any fatty acid salts present in the inventive mixture, and the optional list given here does not affect information regarding fatty acid salts whose presence in the inventive composition is obligatory. When information regarding optionally present fatty acid salts contradicts information regarding obligatorily present fatty acid salts, the information regarding the obligatorily present fatty acid salts takes precedence in each case. This is true, for example, for substance information, and likewise for quantitative information.

Typical examples are the sodium, potassium, magnesium, ammonium and triethanolammonium salts of caproic acid, caprylic acid, 2-ethylhexanoic acid, capric acid, lauric acid, isotridecanoic acid, myristic acid, palmitic acid, palmoleic acid, stearic acid, isostearic acid, oleic acid, elaidic acid, petroselic acid, linoleic acid, linolenic acid, eleostearic acid, arachic acid, gadoleic acid, behenic acid and erucic acid, and the technical-grade mixtures thereof. For example, coconut fatty acid or palm kernel fatty acid are used in the form of the sodium or potassium salts thereof.

Monoglyceride sulfates and monoglyceride ether sulfates are known anionic surfactants which can be obtained by the appropriate methods of preparative organic chemistry. Typically, they are prepared proceeding from triglycerides which, optionally after ethoxylation, are transesterified to the monoglycerides and then sulfated and neutralized. It is likewise possible to react the partial glycerides with suitable sulfating agents, preferably gaseous sulfur trioxide or chlorosulfonic acid. Typical examples of monoglyceride (ether) sulfates suitable in the context of the invention are the reaction products of lauric acid monoglyceride, coconut fatty acid monoglyceride, palmitic acid monoglyceride, stearic acid monoglyceride, oleic acid monoglyceride and tallow fatty acid monoglyceride, and the ethylene oxide adducts thereof with sulfur trioxide or chlorosulfonic acid in the form of the sodium salts thereof.

The inventive compositions may contain nonionic surfactants as surfactants or as emulsifiers. Typical examples of nonionic surfactants are alkoxylates of alkanols, endgroup-capped alkoxylates of alkanols with no free OH groups, alkoxylated fatty acid lower alkyl esters, hydroxy mixed ethers, alkylphenol polyglycol ethers, fatty acid polyglycol esters, fatty acid amide polyglycol ethers, fatty amine polyglycol ethers, alkoxylated triglycerides, mixed ethers or mixed formals, alk(en)yl oligoglycosides, fatty acid N-alkylglucamides, protein hydrolyzates (especially wheat-based vegetable products), polyol fatty acid esters, sugar esters, sorbitan esters, polysorbates and amine oxides. When the nonionic surfactants contain polyglycol ether chains, they may have a conventional, but preferably a narrowed, homolog distribution.

Suitable examples are the nonionic surfactants selected from the group formed by alkyl and/or alkenyl oligoglycosides, hydroxy mixed ethers, alkoxylates of alkanols, especially fatty alcohol polyethylene glycol/polypropylene glycol ethers (FAEO/PO) or fatty alcohol polypropylene glycol/polyethylene glycol ethers (FAPO/EO), endgroup-capped alkoxylates of alkanols, especially endgroup-capped fatty alcohol polyethylene glycol/polypropylene glycol ethers or endgroup-capped fatty alcohol polypropylene glycol/polyethylene glycol ethers, and fatty acid lower alkyl esters and amine oxides.

Likewise suitable are the alkyl and/or alkenyl oligoglycosides. The alkyl and/or alkenyl oligoglycosides may derive from aldoses or ketoses having 5 or 6 carbon atoms, preferably from glucose. The preferred alkyl and/or alkenyl oligoglycosides are therefore alkyl and/or alkenyl oligoglucosides. The degree of oligomerization p, i.e. the distribution of mono- and oligoglycosides, is, for example, between 1 and 10. While p in a given compound must always be an integer and here may in particular assume the values of p=1 to 6, the value p for a particular alkyl oligoglycoside is an analytically determined theoretical parameter which is usually a fraction. Preference is given to using alkyl and/or alkenyl oligoglycosides with a mean degree of oligomerization p of 1.1 to 3.0. From a performance point of view, preference is given to those alkyl and/or alkenyl oligoglycosides with a degree of oligomerization less than 1.7 and especially between 1.2 and 1.4. The alkyl or alkenyl radical may derive from primary alcohols having 4 to 11 and preferably 8 to 10 carbon atoms. Typical examples are butanol, caproyl alcohol, caprylyl alcohol, capryl alcohol and undecyl alcohol, and the technical-grade mixtures thereof, as obtained, for example, in the hydrogenation of technical-grade fatty acid methyl esters or in the course of the hydrogenation of aldehydes from the Roelen oxo process. The alkyl or alkenyl radical may also derive from primary alcohols having 12 to 22 and preferably 12 to 14 carbon atoms. Typical examples are lauryl alcohol, myristyl alcohol, cetyl alcohol, palmoleyl alcohol, stearyl alcohol, isostearyl alcohol, oleyl alcohol, elaidyl alcohol, petroselinyl alcohol, arachyl alcohol, gadoleyl alcohol, behenyl alcohol, erucyl alcohol, brassidyl alcohol and the technical-grade mixtures thereof, which can be obtained as described above.

Further suitable constituents of the inventive fatty acid salt mixtures are hydroxy mixed ethers, which derive, for example, from alkoxylates of monohydric aliphatic, saturated, straight-chain or branched alcohols having 4 to 18 carbon atoms.

Examples of suitable straight-chain alcohols are butanol-1, caproyl alcohol, enanthyl alcohol, caprylyl alcohol, pelargonyl alcohol, capryl alcohol, undecanol-1, lauryl alcohol, tridecanol-1, myristyl alcohol, pentadecanol-1, palmityl alcohol, heptadecanol-1, stearyl alcohol, nonadecanol-1, arachidyl alcohol, heneicosanol-1, behenyl alcohol and the technical-grade mixtures thereof, as obtained in the high-pressure hydrogenation of technical-grade methyl esters based on fats and oils. Examples of such branched alcohols are what are known as the oxo process alcohols, which usually bear 2 to 4 methyl groups as branches and are prepared by the oxo process, and what are known as Guerbet alcohols which are 2-branched with an alkyl group. Suitable Guerbet alcohols are 2-ethylhexanol, 2-butyloctanol, 2-hexyldecanol and/or 2-octyldodecanol.

The alcohols can be used, for example, in the form of their alkoxylates, which are prepared in a known manner by reacting the alcohols in any sequence with ethylene oxide, propylene oxide and/or butylene oxide.

Likewise suitable are fatty alcohol polyethylene glycol/polypropylene glycol ethers or fatty alcohol polypropylene glycol/polyethylene glycol ethers, which are optionally endgroup-capped. For example, the fatty alcohol radical is an aliphatic, saturated, straight-chain or branched alkyl radical having 8 to 16 carbon atoms. The fatty alcohol polyethylene glycol/polypropylene glycol ethers or fatty alcohol polypropylene glycol/polyethylene glycol ethers useable in accordance with the invention are, for example, addition products of 1 to 20 mol of ethylene oxide onto monofunctional alcohols. Suitable alcohols are the above-described alcohols such as fatty alcohols, oxo process alcohols and Guerbet alcohols. Among such alcohol ethoxylates, those which have a narrowed homolog distribution are likewise suitable.

The endgroup-capped compounds are capped, for example, by an alkyl group having 1 to 8 carbon atoms. Frequently, such compounds are also referred to in the literature as mixed ethers. Suitable representatives are methyl group-capped compounds. Such compounds can be prepared easily by reacting the corresponding non-endgroup-capped fatty alcohol polyethylene glycol/polypropylene glycol ethers with methyl chloride in the presence of a base.

Likewise suitable as surfactants or emulsifiers in the context of the inventive compositions are alkoxylated fatty acid lower alkyl esters. Typical examples are the formal insertion products of an average of 1 to 20 and preferably 5 to 10 mol of ethylene oxide and/or propylene oxide into the methyl, ethyl, propyl, isopropyl, butyl and tert-butyl esters of caproic acid, caprylic acid, 2-ethylhexanoic acid, capric acid, lauric acid, isotridecanoic acid, myristic acid, palmitic acid, palmoleic acid, stearic acid, isostearic acid, oleic acid, elaidic acid, petroselic acid, linoleic acid, linolenic acid, eleostearic acid, arachic acid, gadoleic acid, behenic acid and erucic acid, and the technical-grade mixtures thereof. The products are typically prepared by inserting the alkoxides into the carbonyl ester bond in the presence of specific catalysts, for example calcined hydrotalcite. Particular preference is given to reaction products of an average of 5 to 10 mol of ethylene oxide into the ester bond of technical-grade coconut fatty acid methyl esters.

Likewise suitable as surfactants or emulsifiers in the context of the inventive compositions are amine oxides or alkylamidoamine oxides.

An inventive composition may additionally also comprise one or more cationic surfactants. Suitable cationic surfactants are especially those which contain a quaternary ammonium group. They may be cationic or amphoteric betaine surfactants. Suitable cationic surfactants contain amino groups or quaternized hydrophilic ammonium groups which, in solution, bear a positive charge and can be represented by the general formula N⁽⁺⁾R¹R²R³R⁴X⁽⁻⁾ where R¹ to R⁴ are each independently aliphatic groups, aromatic groups, alkoxy groups, polyoxyalkylene groups, alkylamido groups, hydroxyalkyl groups, aryl groups or alkaryl groups each having 1 to 22 carbon atoms, and X(−) is a cosmetically compatible anion selected from halogen, acetate, phosphate, nitrate or alkylsulfate, preferably a chloride.

In order to ensure the surfactant properties, at least one of the R¹ to R⁴ radicals has at least 8 carbon atoms. In addition to the carbon atoms and the hydrogen atoms, the aliphatic groups may also contain cross-bonds or other groups, for example further amino groups. Examples of suitable cationic surfactants are especially quaternary ammonium compounds, preference being given to ammonium halides, especially the chlorides or bromides thereof, such as alkyldimethylbenzylammonium salts, alkyltrimethyl-ammonium salts, dialkyldimethylammonium chlorides and trialkylmethylammonium chlorides or the bromides thereof, for example cetyltrimethylammonium chloride or bromide, stearyltrimethylammonium chloride or bromide, distearyltrimethylammonium chloride or bromide, lauryldimethylbenzylammonium chloride or bromide, tetradecyltrimethylammonium chloride or bromide, alkyldimethylhydroxyethylammonium chloride or bromide, alkyltrimethylammonium chloride or bromide, dialkyldimethylammonium chloride or bromide, alkylpyridinium salts, for example lauryl- or cetylpyridinium chloride, alkylamidoethyltrimethylammonium ether sulfates, and compounds with cationic character, such as amine oxides, for example alkylmethylamine oxides or alkylaminoethyldimethylamine oxides.

In a preferred embodiment, the inventive compositions contain 0 to about 50% by weight, for example about 0 to about 50 or about 1 to about 30 or about 2 to about 25 or about 3 to about 22 or about 4 to about 20 or about 5 to about 15 or about 7 to about 13 or about 8 to about 12, for example about 9 to about 11 or about 10% by weight, of anionic, cationic or nonionic surfactants, or mixtures of two or more thereof, for example a mixture of one or more anionic surfactants and one or more nonionic surfactants or one or more cationic surfactants or one or more nonionic surfactants, calculated as active substance, based on the overall composition.

Preferred colloids are partly hydrolyzed and fully hydrolyzed polyvinyl alcohols; polyvinylpyrrolidones, polyvinyl acetals, polysaccharides in water-soluble form, such as starches (amylose and amylopectin), celluloses and the carboxymethyl, methyl, hydroxyethyl, hydroxypropyl derivatives thereof, proteins such as casein or caseinate, soy protein, gelatin, lignosulfonates, synthetic polymers such as poly(meth)acrylic acid, copolymers of (meth)acrylates with carboxyl-functional comonomer units, poly(meth)acrylamide, polyvinylsulfonic acids and the water-soluble copolymers thereof; melamine formaldehydesulfonates, naphthalene formaldehydesulfonates, styrene-maleic acid and vinyl ether-maleic acid copolymers. The proportion of colloids is preferably between 20 and 80% by weight, especially between 50 and 60%. Preferably at least 2, 5 or 10%, and not more than 20, 50 or 80%, of colloids is present.

The colloids used are preferably partly hydrolyzed or fully hydrolyzed polyvinyl alcohols with a degree of hydrolysis of 80 to 100 mol %, especially of 80 to 95 mol %, and a Happier viscosity (in 4% aqueous solution) of 1 to 30 mPas, preferably 3 to 15 mPas (method according to Höppier at 20° C., DIN 53015). Preference is also given to partly hydrolyzed or fully hydrolyzed, hydrophobically modified polyvinyl alcohols with a degree of hydrolysis of 80 to 100 mol % and a Höppier viscosity in 4% aqueous solution of 1 to 30 mPas, preferably 3 to 15 mPas. Examples thereof are partly hydrolyzed copolymers of vinyl acetate with hydrophobic comonomers such as isopropenyl acetate, vinyl pivalate, vinyl ethylhexanoate, vinyl esters of saturated alpha-branched monocarboxylic acids having 5 to 11 carbon atoms, dialkyl maleates and dialkyl fumarates such as diisopropyl maleate and diisopropyl fumarate, vinyl chloride, vinyl alkyl ethers such as vinyl butyl ether, alpha-olefins having 2 to 12 carbon atoms, such as ethene, propene and decene. The proportion of the hydrophobic units is preferably 0.1 to 10% by weight, based on the total weight of the partly or fully hydrolyzed polyvinyl alcohol. Particular preference is given to partly hydrolyzed or fully hydrolyzed copolymers of vinyl acetate with isopropenyl acetate having a degree of hydrolysis of 95 to 100 mol %. It is also possible to use mixtures of the polyvinyl alcohols mentioned.

Particularly preferred polymers are those which are redispersible in water. Suitable polymers are those based on one or more monomers from the group comprising vinyl esters of unbranched or branched alkylcarboxylic acids having 1 to 15 carbon atoms, methacrylic esters and acrylic esters of alcohols having 1 to 15 carbon atoms, vinylaromatics, olefins, dienes and vinyl halides. Further suitable polymers are specified in WO 2004/103928 on pages 8 to 10, to which explicit reference is made here.

To increase the storability, an antiblocking agent (anticaking agent) can be added. Examples of antiblocking agents are calcium and magnesium carbonate, tallow, silica, kaolins, silicates, preferably with particle sizes in the range between 10 nm and 100 μm. The proportion of the antiblocking agents in the inventive hydrophobing agent is, in preferred embodiments, between 0.5 and 30% and especially between 1 and 20% by weight. Preferably up to 5, 10 or 20% by weight of antiblocking agent is present.

Fillers preferred in accordance with the invention are mineral or inorganic fillers, for example clays, sand, grit, slag, glass, silica gels, sulfates, oxides, glass and mineral fibers, polymer fibers, hollow microspheres, light organic fillers (for example polystyrene foam), paper powder, wood shavings and cellulose fibers. The fillers may be part of the inventive fatty acid salt mixture.

Further additives used may, for example, be organo(poly)siloxanes. Corresponding materials are disclosed in DE 601 08 152 T2, especially in paragraphs [0015] to [0017], to which explicit reference is made here.

Viscosity improvers serve, for example, to alter the flow properties or the processability of a fatty acid salt mixture. Additives which alter the flow behavior of the render are also referred to as rheology-altering additives.

The pigments used may, for example, be titanium dioxide, zinc oxide or zinc sulfide.

An inventive fatty acid salt mixture may be present, for example, as a granule, powder, solution, dispersion or emulsion. It is preferred in some cases when the inventive fatty acid salt mixture is provided, for example, in the form of a granule. Such a granulated fatty acid salt mixture can be prepared by customary or known granulation processes. In a particularly preferred embodiment of the invention, the fatty acid salt mixture is a granule which contains at least the following components
35 to 95 or 40 to 95% by weight of fatty acid salts,
1 to 20% by weight of at least one mono- or polyhydric alcohol
4 to 50% by weight of a water-soluble or water-dispersible binder
0 to 60 or 0 to 60% by weight of at least one emulsifier or surfactant or both and
0 to 30% by weight of further additives.

In a further embodiment of the invention, the inventive fatty acid salt mixture can be used as a powder. Such powders can be applied to the surface of the grains of the construction material, for example, by mixing with a construction material, for example a mortar.

The inventive fatty acid salt mixture may also be present on a carrier material and, for example, have a structure corresponding to a core-shell structure. A core-shell structure is understood in the context of the present invention to mean a structure in which the composition of the solid particle, proceeding from the center of the particle, toward the edges changes in such a way that the edge has a different composition than the middle. In the context of the present invention, such changes may be continuous or essentially discontinuous, or be a mixture of the two phenomena. A “predominantly core-shell structure” is understood in the context of the present invention to mean the finding that the core-shell structure can be detected for at least about 40% of the surface of the solid particle. Corresponding detection methods are known to those skilled in the art; for example, the solid particles can be analyzed by electron microscopy.

The core materials used in the context of the present invention are, for example, inorganic carriers such as chalk or titanium dioxide, inorganic porous carriers such as montmorillonite, bleaching earth and the like, organic carriers such as starch, microcellulose and the like, and also zeolites or hollow microbodies, or mixtures of two or more thereof.

The invention accordingly also provides a construction material which comprises an inventive fatty acid salt mixture. In preferred embodiments of the invention, the construction material comprises a binder, for example mortar, lime, cement or concrete. In a further preferred embodiment, it comprises a solvent, especially water. In a preferred embodiment of the invention, the mineral construction material is selected from the group consisting of screed, render, construction adhesive, spackling compound, leveling compound, sealing compound, jointing mortar, hybrid materials such as lightweight concrete with wood shavings or wood flour, synthetic resin renders and paint. It is preferred in the context of the present invention when the construction material is not gypsum.

The term “render” refers to the solid mortar applied and solidified on the built structure. In a particularly preferred embodiment, the render is a cement render, especially a lime cement render. A render mortar comprises at least one binder. The binders used may, for example, be cements, lime-cement mixtures or lime mixtures. The production and processing of render mortars as a construction material for production of render is divided into five groups according to DIN 18550. According to the invention, the hydrophobing agent is used, for example, for render mortars from the groups of lime mortar (mixture of sand and quicklime), lime-cement mortar (mixture of sand, quicklime and cement), cement mortar (mixture of sand and cement) and anhydrite mortar (mixture of sand and anhydrite). Exterior renders used are especially lime-cement mortar and cement mortar.

The inventive construction material can be processed, for example, with the additives referred to above. It is at the discretion of the person skilled in the art whether these additives are added to the hydrophobing agent or directly to the construction material.

The preferred proportion of the inventive hydrophobing agent in the construction material is preferably between 0.01 and 5% by weight, more preferably between 0.2 and 3% by weight and between 0.5 and 1% by weight. In particularly preferred embodiments, at least 0.01, 0.02 or 0.5% by weight and/or up to 0.5, 1 or 2% by weight of the inventive hydrophobing agent is present.

The invention also provides a hydrophobed component, obtainable by a process in which an inventive fatty acid salt mixture is added to a mineral construction material and mixed, and the construction material is set. The construction material is preferably not gypsum.

The invention also provides for the use of a fatty acid salt mixture for hydrophobing mineral construction materials, wherein the proportion of the fatty acid salts having 8 to 17 carbon atoms in all of the fatty acid salts amounts to 20% by weight or more than 20% by weight, or the proportion of fatty acids having 8 to 14 carbon atoms amounts to 10% by weight or more than 10% by weight, based on the total amount of the fatty acid salts in the fatty acid salt mixture, or both.

In a preferred embodiment of the invention, the use is effected such that the proportion of the fatty acid salts having 8 to 17 carbon atoms in all of the fatty acid salts amounts to more than 50% by weight. In a further preferred embodiment, in the inventive use, the fatty acid salt which amounts to the greatest proportion in percent by weight of all of the fatty acid salts used is a salt of a fatty acid having 8 to 17 carbon atoms. In a particularly preferred embodiment of the invention, the mean chain length of all of the fatty acid salts used is between 12 and 16 carbon atoms.

In a preferred embodiment, fatty acid salts selected from the group consisting of fatty acid salts of caprylic acid, pelargonic acid, capric acid, lauric acid, myristic acid, palmitic acid, margaric acid, undecylenic acid and palmitoleic acid, and the cleavage products of castor oil or of further hydroxy fatty acids are used. In a preferred embodiment, the sum of the proportions of the fatty acid salts of caprylic acid, lauric acid and myristic acid in all of the fatty acid salts amount to more than 50% by weight. In a preferred embodiment, the total proportion of the fatty acid salts in the hydrophobing agent is between 5 and 95% by weight. In a further preferred embodiment of the invention, the fatty acid salts are hydrolysis products or oxidation products of a natural fat.

The invention also relates to a process for preparing a fatty acid salt mixture, in which, as the reactant, a fatty acid mixture or a mixture of fatty acid esters or a mixture of fatty acids and fatty acid esters, the proportion of fatty acids having 8 to 17 carbon atoms in the fatty acid mixture or the mixture of fatty acid esters amounting to 20% by weight or more than 20% by weight, is admixed simultaneously or successively with at least two metal compounds of metals from the group of the alkali metals, alkaline earth metals, zinc, aluminum or the rare earths, which are capable of salt formation with fatty acids under the process conditions selected, or at least two amino compounds which are capable of ammonium salt formation with fatty acids under the process conditions selected, such that the product formed is a mixture of fatty acid salts having at least two different metal cations or two different ammonium cations, or a mixture of at least one metal cation and at least one ammonium cation, the metal cations being selected from the group consisting of alkali metals, alkaline earth metals, zinc, aluminum and rare earths, and the proportion of the fatty acid salts of fatty acids having 8 to 17 carbon atoms, based on the total amount of the fatty acid salts in the fatty acid salt mixture, amounting to 20% by weight or more than 20% by weight, or the proportion of fatty acids having 8 to 14 carbon atoms amounting to 10% by weight or more than 10% by weight, based on the total amount of the fatty acid salts in the fatty acid salt mixture, or both.

For example, the metal compounds of metals from the group of the alkali metals, alkaline earth metals, zinc, aluminum or the rare earths, which are capable of salt formation with fatty acids under the process conditions selected, are basic compounds, especially compounds from the group of the oxides, hydroxides, carbonates.

For example, the compounds used of metals from the group of the alkali metals, alkaline earth metals, zinc, aluminum or the rare earths, or the ammonium compounds used, which are capable of salt formation with fatty acids under the process conditions selected, may be calcium hydroxide, sodium hydroxide, potassium hydroxide or ammonium hydroxide.

The reactant used is, for example, a mixture of fatty acid esters, especially of triglycerides. The process according to the invention is particularly suitable when the mixture of fatty acid esters used is a natural fat or oil.

The process according to the invention can, for example, also be performed by using the at least two compounds of metals from the group of the alkali metals, alkaline earth metals, zinc, aluminum or the rare earths, or amino compounds which are capable of salt formation with fatty acids under the process conditions selected, in an amount of 5 to 95% by weight, based on the weight of the fatty acid mixture or of the mixture of fatty acid esters or of the mixture of fatty acids and fatty acid esters.

In further preferred embodiments, additives are present, as described above for the inventive fatty acid salt mixtures. Particular preference is given to solvents, solubilizers, fillers, further hydrophobing agents, binders, surfactants, emulsifiers, viscosity improvers, surfactants, pigments, dyes, preservatives, gelating agents, anticaking agents, pH modifiers, buffers, reaction accelerants, reaction retardants, colloids, polymers and/or air entrainers is present. In preferred embodiments, use is effected as granules, powder, solution, dispersion or emulsion.

The invention also provides a process for hydrophobing mineral construction materials, wherein an inventive hydrophobing agent is added to a mineral construction material and mixed. The mixing precedes the setting of the construction material. This process is also referred to as “secondary hydrophobing”, in contrast to “primary hydrophobing” in which the hydrophobing agent is added subsequently to the set construction material. In addition to the fatty acid salt mixture as the hydrophobing agent, further customary additives are optionally added to the construction material, especially those mentioned above. These are, for example, thixotropic agents which improve the consistency and the stability of a mortar. Specific thixotropic agents are those which alter the flow behavior of the render, and are referred to as rheology-altering additives.

### WORKING EXAMPLES

| No. | Raw material | Amount | Comment |
|---|---|---|---|
| 1. | Palm kernel fat | 250 g | |
| 2. | Sodium hydroxide | 45 g | Pellets |
| 3. | Water | 600 g | |

### 1^{st} Step

### Procedure

2 and 3 were mixed. 1 was melted at 50° C. and gradually mixed with the solution of 2 in 3 by dropwise addition. This was followed by further heating and reaction at 80-100° C. for 90 minutes. Subsequently, the precipitate was coagulated by means of sodium chloride, filtered off and washed, in order to remove the glycerol formed and the sodium chloride formed. This was followed by slurrying in acetone. In the course of this, water and glycerol went into solution and the fatty acid salts remained undissolved. They were then filtered off. The product was first freed of the acetone on a Rotavapor and then dried in a drying cabinet at 110° C. for 6 h.

| No. | Raw material | Amount | Comment |
|---|---|---|---|
| 1. | Product from first step | 80 g | |
| 2. | Water | 21 | |
| 3. | Calcium chloride | 21 g | Pure substance |
| | | | as 30% aqueous |
| | | | solution |

### 2^{nd} Step

### Procedure

Product from the first step was dissolved in water, and CaCl₂ was slowly added dropwise at 70° C. The precipitate was filtered off and washed with 1 l of water. This was followed by drying at 50° C. for 2 days.

### Raw Materials Used

| | | | |
|---|---|---|---|
| No. | Raw material | Amount | Comment |

| | | | | |
|---|---|---|---|---|
| 4. | Sodium salt (1^{st} step) | 2.5 g | A | B |
| 5. | Calcium salt (2^{nd} step) | 7.5 g | A | B |
| 6. | Glycerol | 1.0 g | | B |

### Procedure

Mixtures A and B were Prepared in a Mortar.

### Mixture C

Palm kernel fat was hydrolyzed with sodium hydroxide and calcium hydroxide in a pressure reactor with a catalytic amount of water at 140° C. The ratio of sodium and calcium salt of the palm kernel fat corresponded to mixture B. The glycerol formed remained in a homogeneous mixture in the product.

The following W 24 values were determined to DIN EN ISO 15148 with a use amount of 0.25% in a lime cement render:

| | |
|---|---|
| Mixture A | 3.53% |
| Mixture B (with glycerol) | 2.18% |
| Mixture C (in situ) | 1.27% |
| Mixture D (from 75:25 calcium stearate/sodium oleate) | 2.85% |

1. A fatty acid salt mixture comprising a mixture of fatty acid salts of at least two different metal cations or two different ammonium cations or a mixture of at least one metal cation and at least one ammonium cation, the metal cations being selected from the group consisting of alkali metals, alkaline earth metals, zinc, aluminum and rare earths, and wherein the proportion of the fatty acid salts of fatty acids having 8 to 17 carbon atoms, based on the total amount of the fatty acid salts in the fatty acid salt mixture, amounts to 20% by weight or more than 20% by weight, or the proportion of fatty acids having 8 to 14 carbon atoms amounts to 10% by weight or more than 10% by weight, based on the total amount of the fatty acid salts in the fatty acid salt mixture, or both.

2. The fatty acid salt mixture as claimed in claim 1, wherein at least one fatty acid salt contains one of the metals sodium, potassium, zinc, magnesium or calcium.

3. The fatty acid salt mixture as claimed in claim 1, further comprising a polyhydric alcohol.

4. The fatty acid salt mixture as claimed in claim 1, further comprising at least one additive selected from solvents, binders, polymers, colloids, surfactants, emulsifiers or solvents, or a mixture of two or more thereof.

5. The fatty acid salt mixture as claimed in claim 1, wherein the proportion of the fatty acid salts of fatty acids having 8 to 14 carbon atoms amounts to more than 30% by weight, based on the total amount of the fatty acid salts in the fatty acid salt mixture.

6. The fatty acid salt mixture as claimed in claim 1, wherein the fatty acid salt which amounts to the greatest proportion in percent by weight of all of the fatty acid salts is a salt of a fatty acid having 8 to 17 carbon atoms.

7. The fatty acid salt mixture as claimed in claim 1, wherein the average chain length of all of the fatty acid salts in the fatty acid salt mixture is within a range from 12 to 16 carbon atoms.

8. The fatty acid salt mixture as claimed in claim 1, wherein the fatty acid salts are selected from the group consisting of fatty acid salts of caprylic acid, pelargonic acid, capric acid, lauric acid, myristic acid, palmitic acid, margaric acid, undecylenic acid, palmitoleic acid, and mixtures thereof.

9. The fatty acid salt mixture as claimed in claim 1, wherein the sum of the proportions of the salts of fatty acids having more than 12 to 16 carbon atoms in the fatty acid radical in all of the fatty acid salts amounts to more than 50% by weight.

10. The fatty acid salt mixture as claimed in claim 1, wherein the total proportion of the fatty acid salts in the fatty acid salt mixture is between 5 and 95% by weight.

11. The fatty acid salt mixture as claimed in claim 1, wherein the fatty acid salts are include hydrolysis products of a natural fat or oil.

12. The fatty acid salt mixture as claimed in claim 1, having the following composition:
5 to 95% by weight of fatty acid salts,
5 to 50% by weight of mono or polyhydric alcohols,
0 to 60% by weight of emulsifiers,
0 to 30% by weight of antiblocking agents,
0 to 30% by weight of binders,
0 to 50% by weight of solvents, and
0 to 30% by weight of polymers.

13. The fatty acid salt mixture as claimed in claim 1, in that it is in the form of a granule, a powder, a solution, a dispersion or an emulsion.

14. A mineral construction material comprising a fatty acid salt mixture as claimed in claim 1.

15. The construction material as claimed in claim 14, further comprising at least one compound selected from solvents, solubilizers, fillers, further hydrophobing agents, binders, surfactants, emulsifiers, viscosity improvers, surfactants, pigments, dyes, preservatives, gelating agents, anticaking agents, pH modifiers, buffers, reaction accelerants, reaction retardants, colloids, polymers and/or air entrainers.

16. The construction material as claimed in claim 14, further comprising a mineral binder.

17. The construction material as claimed in claim 14, further comprising mortar, cement, concrete or solvent, or a mixture of two or more thereof.

18. The construction material as claimed in claim 14, selected from the group consisting of render, construction adhesive, spackling compound, leveling compound, sealing compound, jointing mortar and paint.

19. A hydrophobed component produced by mixing a fatty acid salt mixture as claimed in claim 1 with a mineral construction material and then setting the construction material.

20. A process for hydrophobing mineral construction materials, comprising mixing a hydrophobing agent comprising a mixture of fatty acid salts of at least two different metal cations or two different ammonium cations or a mixture of at least one metal cation and at least one ammonium cation, the metal cations being selected from the group consisting of alkali metals alkaline earth metals zinc aluminum and rare earths wherein the proportion of the fatty acid salts of fatty acids having 8 to 17 carbon atoms, based on the total amount of the fatty acid salts in the fatty acid salt mixture, amounts to 20% by weight or more than 20% by weight, or the proportion of fatty acids having 8 to 14 carbon atoms amounts to 10% by weight or more than 10% by weight, based on the total amount of the fatty acid salts in the fatty acid salt mixture, or both, with a mineral construction material.

21. A process for preparing a fatty acid salt mixture, comprising mixing simultaneously or successively:
as the reactant, a fatty acid mixture, a mixture of fatty acid esters or a mixture of fatty acids and fatty acid esters, the proportion of fatty acids having 8 to 17 carbon atoms in the fatty acid mixture or the mixture of fatty acid esters amounting to 20% by weight or more than 20% by weight, or the proportion of fatty acids having 8 to 14 carbon atoms amounting to more than 10% by weight, based on the total amount of the fatty acid salts in the fatty acid salt mixture, or both; and
at least two compounds capable of salt formation with fatty acids selected from at least two metal compounds of metals from the group of the alkali metals, alkaline earth metals, zinc, aluminum or the rare earths, at least two ammonium compounds, or at least one metal compound of a metal from the group of the alkali metals, alkaline earth metals, zinc, aluminum or the rare earths and at least one ammonium compound,
such that the product formed is a mixture of fatty acid salts of at least two different metals selected from the group consisting of alkali metals, alkaline earth metals, zinc, aluminum and rare earths, at least two different ammonium compounds, or a mixture of at least one metal compound and at least one ammonium compound, wherein the proportion of fatty acid salts of fatty acids having 8 to 17 carbon atoms, based on the total amount of the fatty acid salts in the fatty acid salt mixture, amounts to 20% by weight or more than 20% by weight, or the proportion of fatty acids having 8 to 14 carbon atoms amounts to more than 10% by weight, based on the total amount of the fatty acid salts in the fatty acid salt mixture, or both.

22. The process as claimed in claim 21, wherein the at least two metal compounds of metals from the group of the alkali metals, alkaline earth metals, zinc, aluminum or the rare earths, include basic compounds.

23. The process as claimed in claim 21, wherein the metal compound of metals from the group of the alkali metals, alkaline earth metals, zinc, aluminum or the rare earths, includes calcium hydroxide, sodium hydroxide, potassium hydroxide, or mixtures thereof.

24. The process as claimed in claim 21, wherein the reactant used is a mixture of fatty acid esters.

25. The process as claimed in claim 24, wherein the mixture of fatty acid esters includes a natural fat or oil.

26. The process as claimed in claim 21, wherein the at least two metal compounds of metals from the group of the alkali metals, alkaline earth metals, zinc, aluminum or the rare earths, are used in an amount of 1 to 30% by weight, based on the weight of the fatty acid mixture, the mixture of fatty acid esters, or of the mixture of fatty acids and fatty acid esters, stoichiometric amount.

27. The process as claimed in claim 22, wherein the basic compounds are selected from the group consisting of oxides, hydroxides, carbonates, and mixtures thereof.

28. The process as claimed in claim 26, wherein the at least two metal compounds of metals from the group of the alkali metals, alkaline earth metals, zinc, aluminum or the rare earths, are used in an essentially stoichiometric amount, based on the weight of the fatty acid mixture, the mixture of fatty acid esters, or the mixture of fatty acids and fatty acid esters.
